(19) United States
(12) Patent Application Publication
(10) Pub. No.: US 2024/0050932 A1
(43) Pub. Date: Feb. 15, 2024

(54) A COATING COMPOSITION, COATING AND METHODS OF FORMING THE SAME

(71) Applicant: JK RESEARCH & ENGINEERING PTE. LTD., Singapore (SG)

(72) Inventors: Jiak Kwang Tan, Singapore (SG); Nguan Hwee Tay, Singapore (SG); Chang Wei Kang, Singapore (SG)

(21) Appl. No.: 18/254,875

(22) PCT Filed: Nov. 30, 2020
(86) PCT No.: PCT/SG2020/050705

§ 371 Date: May 29, 2023

(51) Int. Cl. B01J 31/06; B01J 31/38; B01J 21/06; B01J 23/50; B01J 21/04; B01J 35/00; B01J 37/04; B01J 37/00; B01J 37/02; B01J 37/08

(52) U.S. Cl. CPC B01J 31/06; B01J 31/38; B01J 21/063; B01J 23/50; B01J 21/04; B01J 35/0013; B01J 35/006; B01J 35/004; B01J 37/04; B01J 37/0009; B01J 37/0219; B01J 37/08

(57) ABSTRACT

The present invention relates to a coating composition including polysilazane mixed in a suitable solvent, and nanoparticles dispersed therein, a method of forming the coating composition, a method of forming the coating and a coating.

### TECHNICAL FIELD

The present invention relates to a coating composition, a coating and methods of forming the same.

### BACKGROUND

Polysilazane has been widely used for its excellent performance in chemical resistance, higher temperature resistance, hydrophobic properties, and surface hardness. Polysilazanes are thermosetting resin and can be conveniently cured in ambient condition. It can be applied to surface by using conventional solvent-born coating technique such as spray, spin, wipe and dip coating. The cured polysilazne coating may have a thickness of 1-10 μm, and it adheres to the surface via covalence bond. Because of these advantages, polysilazane has been emerged as a leading surface protection coating. There are two types of polysilazane: the in-organic perhydro-polysilazne (PHPS) and the organic polysilazane (OPSZ). For general application, a mixture of PHPS and OPSZ, with suitable composition, is typically used.

Despite these key advantages, the thin polysilazane coating is incapable of providing electrical insulation. In addition, like any other metal or polymer surfaces, a polysilazane coated surface is also subjected to microbial contamination, especially communal and regularly contacted surfaces. Communal surface, or regularly or commonly contacted surface, is contaminated with all kinds of microbial. Such microbial can stay alive and active on the surface up to several hours. It is thus a common source for the spread of the virus during a pandemic. To a certain extent, such contamination aggregates to the spread of virus during a pandemic. The common virus includes influenza A/WSN/33 (H1N1), influenza B/70555, Entero enterovirus 71/4643 (hand-foot-mouth dieses), Covid-19, etc.

Metal, such as copper and aluminium have been known to be a good electrical conductor. Wires and strips made from such material are commonly used as electrical conductors and contacts in many electrical applications such as power generation, power transmission, power distribution, telecommunication, electronic circuitry, electronic appliances and equipment, etc.

Typically, the metal wire or strip is being insulated by a layer of PVC (polyvinyl chloride) or rubber. The layer of PVC or rubber is being coated onto the surface of the metal wire or strip. For electromagnetic applications such as transformers, inductors, motors, speakers, hard disk head actuators, electromagnets, etc, copper wires are insulated (also known as enameled) using a thin layer of polyvinyl formal (formvar), polyurethane, polyamide, polyester, polyester-polyimide, polyamide-polyimide (or amide-imide), and polyimide. For these insulated or enameled wires, the thin insulation layer is typically about 150-200 μm thick, and the operating temperature is typically up to 200° C. This is because the polymer insulation layer may melt at a temperature higher than 200° C. This temperature limitation essentially restricts the electrical load carrying capacity of the copper wire and thus limits the performance of the electromagnetic device.

Furthermore, due to the operating environment of the metal wire or strip, the coating has to be hard to withstand wear and tear and, at the same time, it has to be flexible to allow the copper wire or strip to be laid and be installed in tight-spaced casing of the device.

Therefore, in order to increase the electrical load carrying capacity of the metal wire or strip to improve the performance of the electromagnetic device, a coating that is able to withstand a higher melting temperature, e.g. higher than 200° C., and is able to electrically insulate the metal wire or strip is required. Furthermore, the coating should be relatively hard and yet flexible. In addition, preferably, the manufacturing cost of the metal wire or strip should be relatively low to make it affordable for the wire or strip to be commercially viable.

In addition to the above, it would be beneficial to develop a coating that is able to provide electrical insulation and the abovementioned properties.

Preferably, the coating may be an anti-microbial coating that is thin, durable, and applicable to both indoor and outdoor, and when applied onto these communal surface will help to eliminate or reduce the spread of virus during the pandemic.

### SUMMARY

According to various embodiments, a coating composition including polysilazane mixed in a suitable solvent, and nanoparticles dispersed therein is provided.

According to various embodiments, the coating composition may consist of polysilazane mixed in a suitable solvent, and nanoparticles dispersed therein

According to various embodiments, the polysilazane may include a mixture of perhydro-polysilazane and organic polysilazane.

According to various embodiments, the mass fraction between perhydro-polysilazane and organic polysilazane may be at least 1 to 10.

According to various embodiments, the mass fraction between perhydro-polysilazane and organic polysilazane may be not more than 1 to 3.

According to various embodiments, the weight percent of polysilazane may be any value selected from a range of about 1% to about 10% of the coating composition.

According to various embodiments, the weight percent of polysilazane may be any value selected from a range of about 2% to about 3% of the coating composition.

According to various embodiments, the nanoparticles may be Al₂O₃ nanoparticles.

According to various embodiments, the size of the Al₂O₃ nanoparticles may be any value selected from a range of about 1 nm to about 10 nm.

According to various embodiments, the size of the Al₂O₃ nanoparticles may be any value selected from a range of about 1 nm to about 5 nm.

According to various embodiments, the weight percent of the Al₂O₃ nanoparticles may be at least about 2% and not more than about 5% of the coating composition.

According to various embodiments, the weight percent of the Al₂O₃ nanoparticles may be 2% of the coating composition.

According to various embodiments, the nanoparticles may be TiO2 and Ag nanoparticles.

According to various embodiments, the size of the TiO2 and Ag nanoparticles may be any value selected from a range of about 1 nm to about 10 nm.

According to various embodiments, the size of the TiO2 and Ag nanoparticles may be any value selected from a range of about 1 nm to about 5 nm.

According to various embodiments, the weight percent of the TiO2 and Ag nanoparticles may be at least about 2% and not more than about 5% and at least about 0.1% and not more than about 1% of the coating composition respectively.

According to various embodiments, the solvent may be inert.

According to various embodiments, a method of forming a coating composition is provided. The method includes mixing polysilazane into a suitable solvent, and mixing nanoparticles into the solvent.

According to various embodiments, a method of forming a coating is provided. The method includes applying the abovementioned coating composition onto a substrate, and allowing the coating composition to cure to form the coating.

According to various embodiments, the coating composition may be cured at about 200° C.

According to various embodiments, a coating formed according to the abovemented method is provided.

According to various embodiments, a coating including polysilazane and nanoparticles dispersed therein is provided.

According to various embodiments, a coating consisting of polysilazane and nanoparticles dispersed therein is provided.

### BRIEF DESCRIPTION OF DRAWINGS

FIG. 1 shows a schematic view of an exemplary embodiment of a coating composition.

FIG. 2 shows a flow diagram of a method of forming a coating composition.

FIG. 3 shows a flow diagram of an exemplary method of forming a coating.

FIG. 4 shows a schematic view of an exemplary embodiment of the coating.

### DETAILED DESCRIPTION

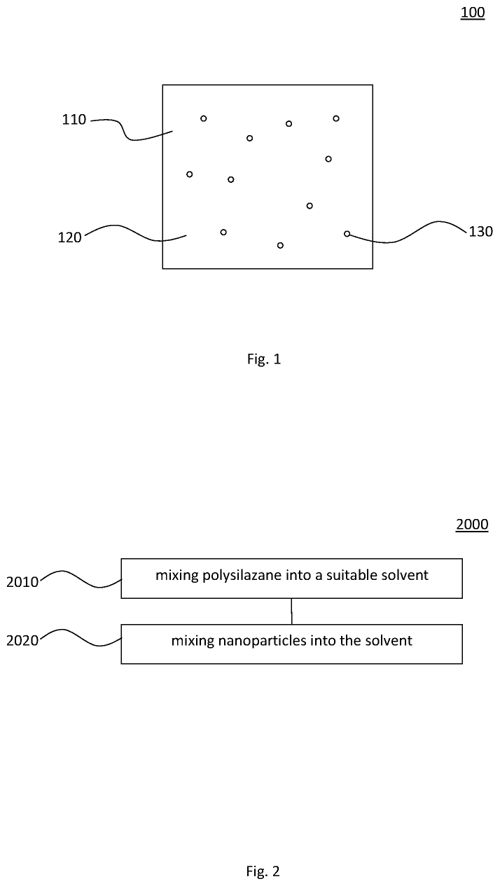

FIG. 1 shows a schematic view of an exemplary embodiment of a coating composition 100. Coating composition 100 includes polysilazane 110 mixed in a suitable solvent 120 and nanoparticles 130 dispersed therein. Coating composition 100 may be coated onto a substrate (not shown in FIG. 1), e.g. metal or polymer. Coating composition 100 may consist essentially of polysilazane 110, nanoparticles 130 and the solvent 120.

Polysilazane 110 may act as a binder to bind the nanoparticles 130. Polysilazane 110 may be composed of organic-polysilazane (OPSZ). Polysilazane 110 may be composed of perhydro-polysilazane (PHPS). Polysilazane 110 may be composed of perhydro-polysilazane and organic-polysilazane. The mass fraction between perhydro-polysilazane and organic polysilazane may be at least 1 to 10. Preferably, the mass fraction may not be more than 1 to 8. Preferably, the mass fraction may not be more than 1 to 5. Preferably, the mass fraction may not be more than 1 to 3.

Coating composition 100 may be composed of polysilazane 110, the nanoparticles 130, and a solvent 120. For example, the coating composition 100 may include a mixture of perhydro-polysilazane and organic-polysilazane in the solvent 120 with the nanoparticles 130 blended and dispersed therein. The weight percent (wt %) of the polysilazane 110 may be any value selected from the range of about 1% to about 10% of the coating composition 100, e.g. about 1% to about 8%, about 1% to 5%. Preferably, the weight percent of the polysilazane 110 may be any value selected from the range of about 2% to about 3% of the coating composition 100 so that the desired thickness of the cured coating may be achieved, e.g. between about 1 μm to about 5 μm. The solvent weight may be at least about 80% of the coating composition 100. Preferably, the solvent weight may be not more than about 99%. Solvent weight may be not more than 90%. Solvent 120 may be inert and may include, but not limited to, di-n-butyl ether, petroleum distillates, and/or alcohols.

Nanoparticles 130 may be Al₂O₃ nanoparticles. Coating of polysilazane 110 with Al₂O₃ nanoparticles dispersed therein has good electrical insulating property and is suitable for electrical insulation for wire and strips, etc. Nanoparticles 130 may be TiO2 and Ag nanoparticles. Coating of polysilazane 110 and TiO2 and Ag nanoparticles dispersed therein has anti-microbial property. Nanoparticles 130 may be of the size of any value selected from a range of about 1 nm to about 10 nm, e.g. 2 nm, 4 nm, 6 nm, 8 nm. Preferably, the size of the nanoparticles 130 may be selected from a range of about 1 nm to 8 nm. Preferably, the size of the nanoparticles 130 may be selected from a range of about 4 nm to 6 nm. Preferably, the size of the nanoparticles 130 may be in the range of 1-5 nm. At this range, it is possible to obtain the coating with a smooth surface. Coating composition 100 may consist of Al₂O₃ nanoparticles and TiO2 and Ag nanoparticles.

The weight percent of the Al₂O₃ nanoparticles may be at least about 2% and not more than about 5% of the coating composition 100, e.g. about 3% to about 4%. Preferably, the weight percent may be about 2% to achieve the desired effect. Coating may be of a thickness of any value selected between about 2 μm to about 10 μm. Coating with the Al₂O₃ nanoparticles may achieve a DC breakdown voltage of up to 40 MV/m. Coating with the Al₂O₃ nanoparticles may withstand a temperature of up to 500° C.

The weight percent of the TiO₂ and Ag nanoparticles may be at least about 2% and not more than about 5% and at least about 0.1% and not more than about 1% of the coating composition 100 respectively. Preferably, the weight percent may be a value selected from a range of about 2% to about 3% to achieve the desired effect. Coating may be of a thickness of any value selected between 2 μm and 10 μm. Coating with TiO₂ and Ag nanoparticles has photocatalytic characteristic under the UV and visible light respectively. Further, the coating is effective in eradicating virus and bacteria, thus achieving anti-microbial effect.

When the Al₂O₃ nanoparticles and TiO₂ and Ag nanoparticles are mixed into the solvent, the abovementioned weight percent of the Al₂O₃ nanoparticles and TiO₂ and Ag nanoparticles may be applicable.

FIG. 2 shows a flow diagram of a method 2000 of forming a coating composition 100. Method 2000 includes mixing polysilazane 110 into a suitable solvent 120 in block 2010 and mixing nanoparticles 130 into the solvent 120 in block 2020. Method 2000 may include mixing perhydro-polysilazane and organic-polysilazane into the solvent 120 to obtain a mixture, blending the nanoparticles 130 into the mixture to obtain the coating composition 100. Blending the nanoparticles 130 may include shaking or mixing the mixture with the nanoparticles 130 vigorously for a duration of any value selected from a range of at least about 30 minutes and not more than about 60 minutes, e.g. 45 minutes. Method may include blending Al₂O₃ nanoparticles and TiO₂ and Ag nanoparticles into the mixture.

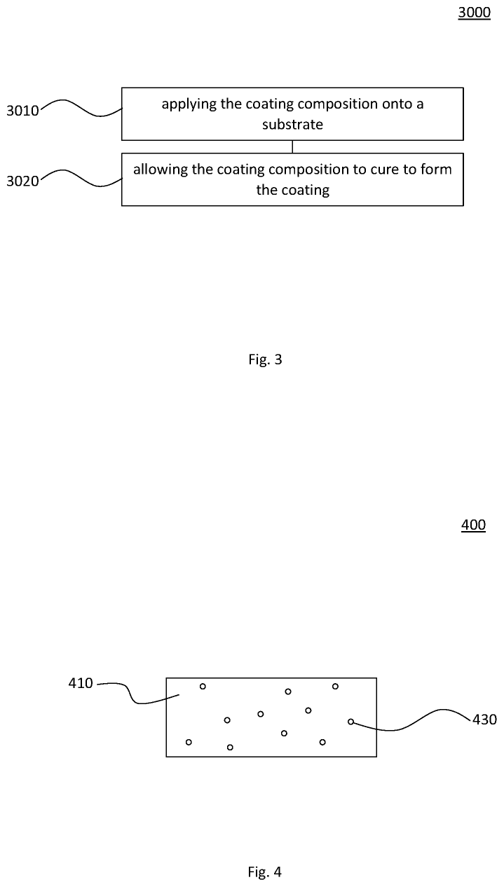

FIG. 3 shows a flow diagram of an exemplary method 300 of forming a coating. Method 3000 includes applying the coating composition 100 onto the substrate, allowing the coating composition 100 to cure to form the coating. Coating composition 100 may be cured at an ambient temperature, e.g. about 25° C. to about 30° C. Coating composition 100 may be cured for a duration of any value in the range of about 6 hours to about 8 hours. Curing may take place at an elevated temperature in a range of about 150° C. to about 250° C., e.g. 200° C. At such a temperature, curing may take place for a duration of about 2-3 minutes.

FIG. 4 shows a schematic view of an exemplary embodiment of the coating 400. Coating 400 may be formed by the abovementioned method 3000 of forming a coating. Coating may include polysilazane 410 and nanoparticles 430. Coating may include essentially of polysilazane 410 and nanoparticles 420. Polysilazane 410 may include perhydro-polysilazane and organic-polysilazane. Nanoparticles 430 may be Al₂O₃ nanoparticles. Nanoparticles 130 may be TiO₂ and Ag nanoparticles. Nanoparticles 430 may be of the size of any value selected from a range of about 1 nm to about 10 nm, e.g. 2 nm, 4 nm, 6 nm, 8 nm. Preferably, the size of the nanoparticles 130 may be selected from a range of about 1 nm to 8 nm. Preferably, the size of the nanoparticles 130 may be selected from a range of about 4 nm to 6 nm. Preferably, the size of the nanoparticles 130 may be in the range of 1-5 nm. Coating may consist of Al₂O₃ nanoparticles and TiO₂ and Ag nanoparticles.

1-23. (canceled)

24. A coating composition comprising:
polysilazane mixed in a suitable solvent, wherein the polysilazane comprises of a mixture of perhydro-polysilazane and organic polysilazane and wherein the perhydro-polysilazane is no more than 1 part to 3 parts by a mass fraction of the organic polysilazane, and
TiO2 nanoparticles and Ag nanoparticles dispersed therein.

25. The coating composition according to claim 24, wherein the coating composition consists of polysilazane mixed in the suitable solvent, and nanoparticles dispersed therein.

26. The coating composition according to claim 24, wherein the mass fraction between perhydro-polysilazane is at least 1 part to 10 parts by mass of the organic polysilazane.

27. The coating composition according to claim 24, wherein a weight percent of polysilazane is any value selected from a range of about 1% to about 10% of the coating composition.

28. The coating composition according to claim 24, wherein a weight percent of polysilazane is any value selected from a range of about 2% to about 3% of the coating composition.

29. The coating composition according to claim 24, further comprising Al₂O₃ nanoparticles having a size.

30. The coating composition according to claim 29, wherein the size of the Al₂O₃ nanoparticles is any value selected from a range of about 1 nm to about 10 nm.

31. The coating composition according to claim 29, wherein the size of the Al₂O₃ nanoparticles is any value selected from a range of about 1 nm to about 5 nm.

32. The coating composition according to any one of claim 29, wherein a weight percent of the Al₂O₃ nanoparticles is at least about 2% and not more than about 5% of the coating composition.

33. The coating composition according to claim 29, wherein a weight percent of the Al₂O₃ nanoparticles is 2% of the coating composition.

34. The coating composition according to claim 24, wherein a size of the TiO₂ nanoparticles and a size of the Ag nanoparticles is any value selected from a range of about 1 nm to about 10 nm.

35. The coating composition according to claim 24, wherein a size of the TiO₂ nanoparticles and a size of the Ag nanoparticles is any value selected from a range of about 1 nm to about 5 nm.

36. The coating composition according to claim 24, wherein a weight percent of the TiO₂ nanoparticles and Ag nanoparticles is at least about 2% and not more than about 5% and at least about 0.1% and not more than about 1% of the coating composition respectively.

37. The coating composition according to claim 24, wherein the suitable solvent is inert.

38. A method of forming a coating composition, the method comprising:
mixing polysilazane into a suitable solvent to form a mixture,
wherein the polysilazane comprises of a mixture of perhydro-polysilazane and organic polysilazane; and
wherein perhydro-polysilazane is no more than 1 part to 3 parts by mass of the organic polysilazane, and
mixing TiO2 nanoparticles and Ag nanoparticles into the mixture comprising the organic polysilazane and the suitable solvent.

39. A method of forming a coating, the method comprising:
applying the coating composition onto a substrate, and
allowing the coating composition to cure to form the coating.

40. The method according to claim 39, wherein the coating composition is cured at about 200° C.

41. The method of claim 39, wherein the coating comprising:
polysilazane; and
TiO2 nanoparticles and Ag nanoparticles dispersed in the polysilazane,
wherein the polysilazane comprises of a mixture of perhydro-polysilazane and organic polysilazane; and
wherein the perhydro-polysilazane is no more than 1 part to 3 parts by mass of the organic polysilazane.

42. The method of claim 39, wherein the coating consisting of:
polysilazane; and
TiO2 nanoparticles and Ag nanoparticles dispersed in the polysilazane,
wherein the polysilazane comprises of a mixture of perhydro-polysilazane and organic polysilazane; and
wherein the perhydro-polysilazane is no more than 1 part to 3 parts by mass of the organic polysilazane.
